(19) United States
(12) Patent Application Publication
(10) Pub. No.: US 2012/0226440 A1
(43) Pub. Date: Sep. 6, 2012

(54) SYSTEMS AND METHODS FOR MANAGING MOBILE ASSETS USING ESTIMATED TIME OF ARRIVAL INFORMATION

(75) Inventor: PARESH L. NAGDA, Pleasanton, CA (US)

(73) Assignee: Navman Wiresless North America LP, Pleasanton, CA (US)

(21) Appl. No.: 13/039,175

(22) Filed: Mar. 2, 2011

(51) Int. Cl. G01C 21/00; G06F 17/30

(52) U.S. Cl. 701/465; 707/812; 707/E17.005

(57) ABSTRACT

Systems and methods for using estimated time of arrival information (ETA) for vehicles. A navigation device located in a vehicle determines the vehicle's present location, route, and ETA information. A tracking device coupled to the navigation device provides ETA information on a network. The network connection configured to transmit the ETA information from the navigation device to a recipient outside the vehicle.

### TECHNICAL FIELD

This invention relates generally to managing mobile assets, and more specifically, to managing mobile assets based at least in part on estimated time of arrival information.

### BACKGROUND OF THE INVENTION

The global positioning system (GPS) is a space-based navigation system including a network of orbiting satellites (called NAVSTAR). Although established for military applications by the U.S. Department of Defense, in the 1980s the system was made available for civilian use. When locked onto the signal of at least three satellites, a GPS receiver may calculate a 2D position (latitude and longitude). When locked onto the signal of at least four satellites, a GPS receiver may calculate a 3D position (latitude, longitude and altitude), subject to the accuracy of map information in the receiver and accuracy of the location calculation. The GPS also provides highly accurate timestamps.

When used in a vehicle and once a GPS navigation system has determined its location using signals from the orbiting satellites, the GPS navigation system may display a map and instruct a driver by providing graphical information, as well as via text or speech on how to get to a destination. GPS navigation systems may be used to navigate in unfamiliar areas with reduced risk of getting lost, subject to the accuracy of the location information and maps used by the GPS navigation system. When a driver becomes lost, valuable time is lost and the driver could become late for a delivery, appointment, or arrival at a work site.

Different businesses, such as shipping and distribution companies, cargo systems companies, maintenance, repair and operations (MRO) organizations, service vehicle operators, cable television operators, schools, construction companies, and the like operate a fleet of mobile assets. Mobile assets, for example, may be vehicles such as delivery trucks, maintenance vans, school busses, heavy equipment, etc. Supervisors and dispatchers at such businesses may schedule when and allocate where the mobile assets should be during the course of a working day (e.g., delivery route, service call appointment schedule, bus route, job site schedule, etc.) to derive optimum benefit from the mobile asset for their organizations. As such, mobile assets are typically equipped with equipment for tracking and locating, including GPS navigation systems which can also be used to provide the driver with navigation information.

Even with current GPS navigation systems, however, once a vehicle departs, supervisors and dispatchers do not know up to the minute when the vehicle will arrive at its destination (i.e., estimated time of arrival). As road conditions (e.g., traffic and weather) change or a vehicle in the fleet becomes disabled, supervisors and dispatchers do not have important data needed to reallocate resources as necessary to maintain customer service levels. To efficiently allocate mobile assets, dispatchers should know when mobile assets will reach their assigned destinations in real time. With such information, dispatchers can adjust a schedule to adapt to unexpected events or poor road conditions. Also, estimated time of arrival information is useful, for example, because customers may need to know when their delivery will arrive (e.g., in limited asset or lean inventory operations).

### BRIEF DESCRIPTION OF THE DRAWINGS

FIG. 1 is a block diagram of a system using estimated time of arrival information according to an embodiment of the present invention.

FIG. 2 is a block diagram of a tracking and navigation device according to an embodiment of the present invention.

FIG. 3 is a block diagram of a tracking and navigation device according to another embodiment of the present invention.

FIG. 4 is a block diagram of a data center according to an embodiment of the present invention.

### DETAILED DESCRIPTION OF THE INVENTION

In the following description, certain details are set forth below to provide a sufficient understanding of the invention. However, it will be clear to one skilled in the art that the invention may be practiced without these particular details. In other instances, well-known circuits, control signals, timing protocols, and software operations have not been shown in detail or omitted entirely in order to avoid unnecessarily obscuring the invention.

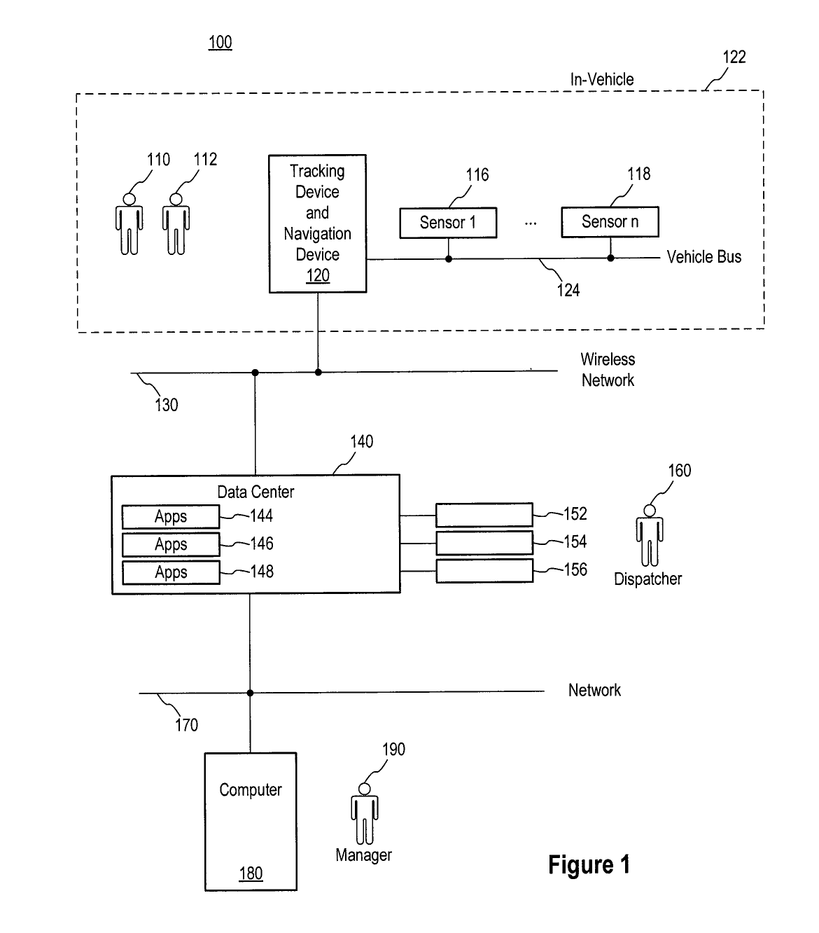

FIG. 1 illustrates a system using estimated time of arrival (ETA) information according to an embodiment of the present invention. Vehicle 122 is operated by driver 110 and optionally co-driver 112. Vehicle 122 may be a motor vehicle (e.g., delivery truck, field service vehicle, school bus, company car, etc.), heavy equipment (e.g., cherry picker, street sweeper, tractor, etc.), and the like. Driver 110 and/or co-driver 112 interface with tracking device and navigation device 120. Sensors 116-118 are arrayed within vehicle 122 for monitoring and optionally controlling systems. For example, sensors 116-118 may monitor cargo temperature in a truck or van, fuel level, hours on the road, vehicle ignition, door locked/unlocked state, airbag deployment, impact/vehicle collision, vehicle speed and direction, and the like. Sensors 116-118 may control vehicle ignition (e.g., start or turn off engine), adjust temperature in a truck or van, adjust vehicle speed (e.g., slow down), unlock doors, and the like. Vehicle bus 124 connects sensors 116-118 to tracking device and navigation device 120. Vehicle bus 124 may be a wireless or wired bus for communicating data, commands, and optionally provide power (e.g., Controller Area Network (CAN) bus, On-Board Diagnostics (OBD-II), J-Bus, power bus, RS-232, RS-422, RS-484, universal serial bus (USB), 1-Wire, custom bus, etc.).

Tracking device and navigation device 120 provides guidance to a destination based upon such parameters as waypoints, real-time traffic conditions, speed, remaining distance to the destination, and the like. Tracking device and navigation device 120 generates estimated time of arrival (ETA) information and may also determine the geographic location of the vehicle. Tracking device and navigation device 120 may determine a trip route from a starting point (e.g., present location) to the destination based at least on a map database. Information from the tracking device and navigation device 120 may be transmitted over a wireless network 130 to a data center 140. Examples of the information that may provided by the tracking device and navigation device 120 include ETA information, vehicle speed, vehicle direction, cargo temperature, fuel level, hours on the road, and the like. As will be described in more detail below, in some embodiments, the tracking device and navigation device 120 and the data center 140 communicate using messages, for example, an ETA information message including real-time ETA information generated by the tracking device and navigation device 120.

Wireless network 130 may be a local-area network (e.g., Wi-Fi (IEEE 802.11)), and/or wide-area network (e.g., “3G” (i.e., International Mobile Telecommunications-2000 (IMT-2000) (e.g., 3GPP Long Term Evolution (LTE), High-Speed Downlink Packet Access (HSDPA), High-Speed Uplink Packet Access (HSUPA), etc.)), “4G” (e.g., LTE Advanced and WirelessMAN-Advanced), WiMAX (IEEE 802.16m), CDMA2000 (e.g., 1×, 1×RTT, EV-DO Rev. 0, EV-DO Rev. A, and EV-DO Rev. B), global system for mobile communications (GSM) (e.g., general packet radio service (GPRS), and enhanced data rates for GSM evolution (EDGE) or Enhanced GPRS (EGPRS)), integrated digital enhanced network (iDEN), wideband integrated digital enhanced Network (WiDEN), advanced mobile phone system (AMPS), total access communication system (TACS), Extended Total Access Communication System (ETACS), Universal Mobile Telecommunications System (UMTS), and the like).

The data center 140 may be connected to and/or receive transfer information over wireless network 130, store information, run applications 144-148, and provide information to applications 152-156. The applications 152-156 may be “external” to the data center 140 and represent third-party applications utilized by dispatcher 160 in managing mobile assets. Data center 140 may also be connected to and transfer data over network 170. Network 170 may be a wired (e.g., twisted pair, coaxial cable, optical fiber, etc.) and/or wireless (e.g., terrestrial microwave, communications satellites, cellular and PCS systems, wireless LANs, and/or infrared communications) computer network (e.g., the Internet).

Applications 144-148 and 152-156 may use the information provided to the data center 140 by the tracking device and navigation device 120. For example, usable by dispatcher 160, applications 152-156 may perform dispatch, scheduling, and customer relationship management (CRM) functions using ETA information from the tracking device and navigation device 120. In another example, a manager 190 may run applications 144-148 on data center 140 or computer 180 through network 170. For example, using ETA information manager 190 may run applications 144-148 to generate maps showing distances and/or areas covered by mobile assets, reports indicating how often mobile assets arrived at their respective destinations, delay or early arrival exceptions, and the like over a period of time.

Applications 144-148 and 152-156 may also perform other operations such as determining ETA information. In some embodiments, applications 144-148 and 152-156 may respond to requests from dispatcher 160 and/or manager 190 instead of tracking device and navigation device 120. For example, applications 144-148 and 152-156 may respond to an ETA information request with ETA information determined by applications 144-148 and 152-156 instead of (or in addition to) ETA information determined by tracking device and navigation device 120. In addition to driver 110 and co-driver 112 interfacing with tracking device and navigation device 120, dispatcher 160 and/or manager 190 may interface or communicate with tracking device and navigation device 120 through wireless network 130 and network 170 (e.g., specify a destination in an ETA information request).

As will be described in more detail below, by having information generated by the tracking device and navigation device 120 and provided to the data center 140, supervisors and dispatchers may have a realistic view of mobile assets in play and may continuously optimize mobile asset productivity despite changing conditions encountered by the mobile assets. At any given time, an asset that is farther from a destination in distance may be nearer in time than another mobile asset that is closer in distance. This is due to such factors as access to highways, traffic conditions, weather conditions, geographic landmarks such as lakes and mountains, and the like. In addition, the mobile asset's condition (e.g., fuel level, hours on the road, collision detection, etc.) in part determine its ability to perform a given job efficiently (or even at all). Without a holistic, real-time view of each mobile asset, supervisors and dispatchers are unable to switch a job assignment to a mobile asset that can reach a job site the soonest, for example, in a time critical situation. Equipped with information indicative of road conditions, traffic conditions, weather conditions, geographic conditions, vehicle condition, driver condition, etc. supervisors and dispatchers may more accurately assess and assign (and if necessary reassign) jobs to mobile assets which can, for example, provide the quickest service.

Computer 180 may be a workstation, computer, notebook computer, netbook computer, tablet computer, smart phone, PDA, and the like. Computer 180 may include one or more processors, input/output (I/O) devices, and storage. For example, processors can be an ×86, SPARC, PowerPC, ARM, and the like architecture. I/O devices may include a keyboard, mouse, trackball, touchpad, microphone, touch screen, flat panel, electronic ink display, indicator lights, speaker, and the like. Storage, for example, may store firmware, operating system, etc. The firmware and/or operating system may be programmed and tested like software, may be implemented to coordinate operations of the hardware within computer 180, and may contain programming constructs used to perform such operations. Storage may be volatile memory (e.g., RAM, SRAM, etc.), non-volatile memory (e.g., FLASH, EEPROM, etc.), magnetic media (e.g., hard disk drive), and/or removable media (e.g., compact disc (CD), digital versatile disc (DVD), Blu-ray disc (BD), USB, flash drive, secure digital (SD) memory card, secure digital high capacity (SDHC) memory card, etc.).

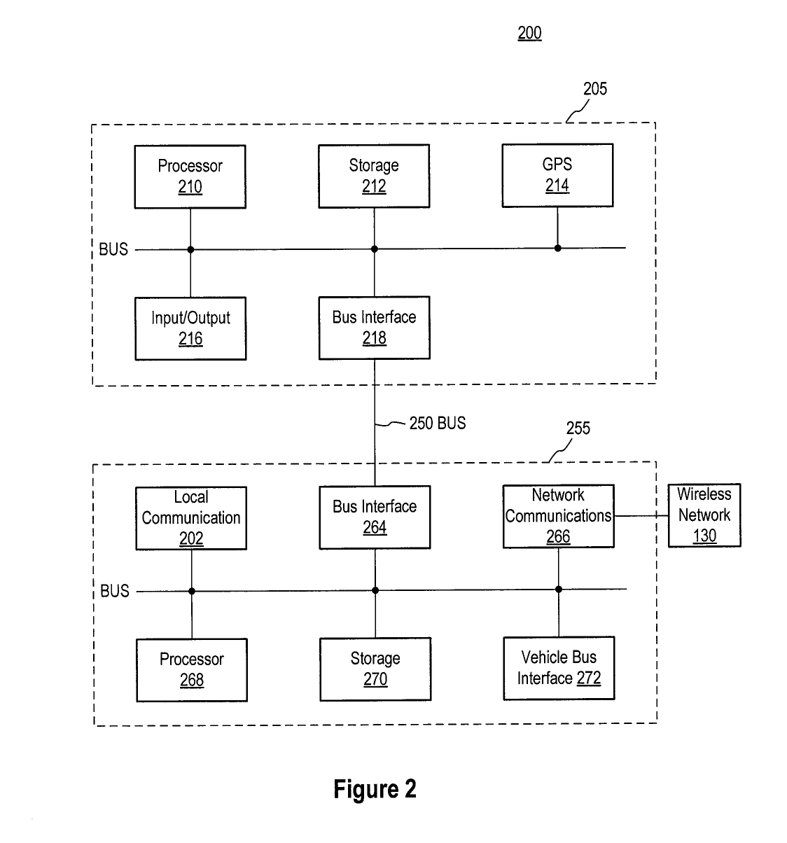

FIG. 2 illustrates a tracking device and navigation device 200 according to an embodiment of the present invention. Tracking device and navigation device 200 may include a navigation device (ND) 205 and tracking device (TD) 255. ND 205 and TD 255 are in communication with one another over a bus 250. ND 205 may include one or more processors 210. Processors 210, for example, may perform functions such as time to go (TTG) value calculation, ETA value estimation, and routing engine and applications engine functionality. A TTG value, for example, may be a time to go determined based in part upon such conditions as current location, destination location, route traveled, way points, average speed for each portion of the route (e.g., based upon the posted speed limit), real-time road conditions (e.g., weather, traffic, construction, automobile accidents) along the route, class of vehicle, type of cargo, choice of toll roads, actual vehicle speed along each portion of the route, and the like. An ETA value, for example, may be determined based upon the TTG value (e.g., ETA=current time+TTG).

In some embodiments, inputs from vehicle sensors, for example, sensors 116-118, provided by TD 255 may be used by the ND 205 to generate and provide more accurate ETA information regularly. Sending real-time information calculated by ND 205 through TD 255 to data center 140, enables applications 144-148 and 152-156 to leverage the real-time information as described below. Processors 210 may be microprocessors (e.g., ×86, ARM, PowerPC, etc.), application specific standard products (e.g., GPS processor), application specific integrated circuits, programmable logic (e.g. field programmable gate arrays (FPGAs)), and the like.

Storage 212, for example, may store a map database, traffic data, configuration information, firmware, operating system, etc. The firmware and/or operating system may be programmed and tested like software, may be implemented to coordinate operations of the hardware within ND 205 (and tracking device and navigation device 200), and may contain programming constructs used to perform such operations. Storage 212 may be volatile memory (e.g., RAM, SRAM, etc.), non-volatile memory (e.g., FLASH, EEPROM, etc.), magnetic media (e.g., hard disk drive), and/or removable media (e.g., CD, DVD, BD, USB flash drive, SD memory card, SDHC memory card, etc.). Global Positioning System (GPS) receiver 214 is configured to receive GPS signals for the purpose of determining the device's current location (on Earth).

ND 205 may also include input/output (I/O) 216 to receive information from and provide information to a user. I/O 216 may include a keyboard, mouse, trackball, touchpad, microphone, touch screen, flat panel, electronic ink display, indicator lights, speaker, and the like. A bus interface 218 enables ND 205 to communicate over bus 250, for example, bus 250 may transfer data (e.g., ETA value) between ND 205 and TD 255. The bus 250 may be wired (e.g., industry standard architecture (ISA), peripheral component interconnect (PCI), RS-232, RS-422, RS-485, Ethernet (IEEE 802.3), custom wired, etc.) and/or wireless (e.g., Wi-Fi (IEEE 802.11), Bluetooth, ZigBee, wireless personal area network (WPAN), etc.).

TD 255 may include one or more processors 268 and storage 270. Processors 268, for example, may perform such functions as local processing of ETA information from ND 205, location calculations, process location events, messaging (i.e., receiving, dissembling, assembling, and transmitting messages), and the like. Processors 268 may be microprocessors (e.g., ×86, ARM, PowerPC, etc.), application specific standard products, application specific integrated circuits, programmable logic (e.g., field programmable gate arrays (FPGAs)), and the like. Storage 270, for example, may store firmware, operating system, etc. The firmware and/or operating system may be programmed and tested like software, may be implemented to coordinate operations of the hardware within TD 255 (and tracking device and navigation device 200), and may contain programming constructs used to perform such operations. Storage 270 may be volatile memory (e.g., RAM, SRAM, etc.), non-volatile memory (e.g., FLASH, EEPROM, etc.), magnetic media (e.g., hard disk drive), and/or removable media (e.g., CD, DVD, BD, USB flash drive, SD memory card, SDHC memory card, etc.).

TD 255 may also include local communications interface 202, bus interface 264, and network communications interface 266. Bus interface 264 enables TD 255 to communicate over bus 250. Vehicle bus interface 272 enables TD 255 to communicate over vehicle bus 124 shown in FIG. 1. Network communications interface enables TD 255 to communicate (e.g., messages) over wireless network 130 shown in FIG. 1.

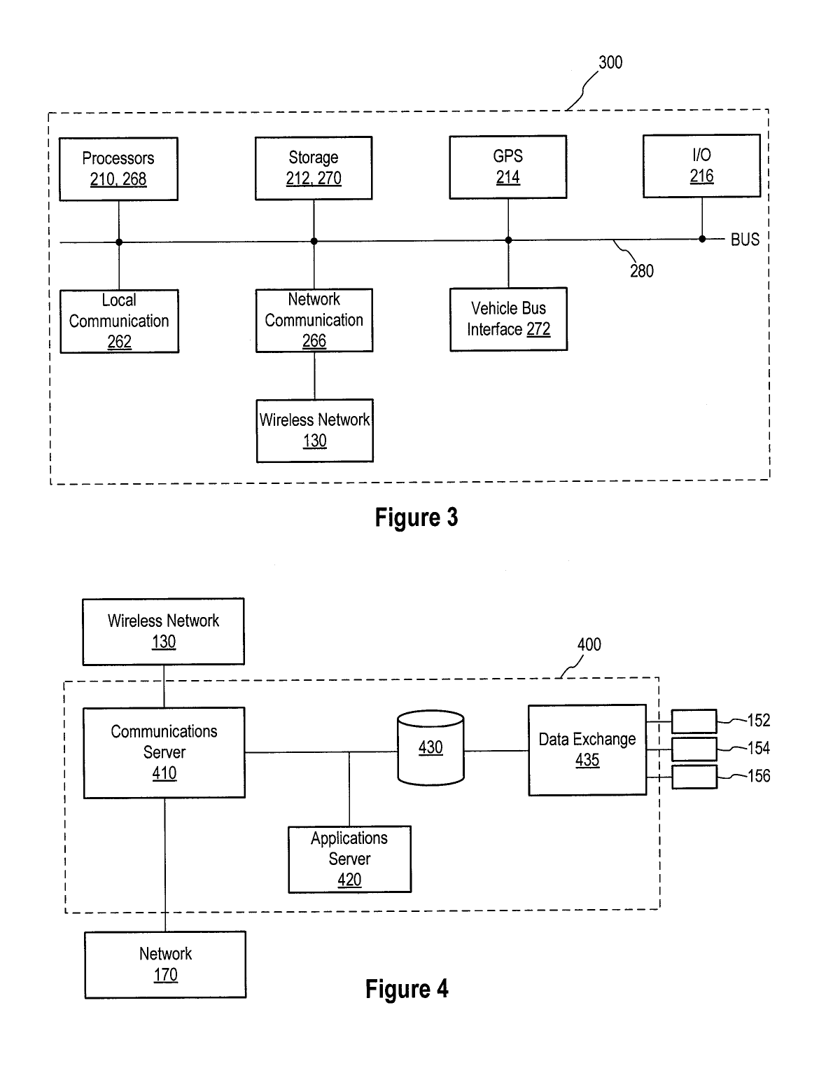

FIG. 3 illustrates a tracking device and navigation device according to another embodiment of the present invention. Tracking and navigation device (TND) 300 integrates ND 205 and TD 255 of FIG. 2 into a common assembly, which may eliminate redundant components, resulting in cost savings and higher reliability. In contrast to tracking device and navigation device 200 of FIG. 2, several components of ND 205 and TD 255 are shared and other components are not included in TND 300. For example, busses 230, 250, and 278 are not included in TND 300 nor are bus interfaces 218, 250, and 264, because the various components communicate over bus 280. In some embodiments, the functions of processors 210, 268 previously described for ND 205 and TD 255 are performed by a single processor. TND 300 may be in one assembly housed within one shielded enclosure. Hence, TND 300 may be more reliable and operate faster than tracking device and navigation device 200 shown in FIG. 2, because communication between ND 205 and TD 255 over bus 250 shown in FIG. 2 must be engineered to withstand a harsh and noisy automotive environment.

Referring to FIGS. 2 and 3, TD 255 and TND 300 (respectively) may send data over wireless network 130 to data center 140 in a message. For example information may be exchanged in messages between TD 255 or TND 300 and data server 140. As previously discussed, the information provided to the data center 140 by the TD 255 or TND 300 may be used by applications 144-148 and 152-156 to assist in managing mobile resources. TD 255 and TND 300 may send ETA information on a regular basis or in response to a request from data center 140. In some embodiments, data center 140 may send an ETA information request including multiple destinations to TD 255 and TND 300. In response to the ETA information request, TD 255 and TND 300 may send ETA information for each destination. An ETA information message, for example, may contain one or more fields containing ETA information for each requested entity (i.e., jobs, vehicles, field workers, etc.). ETA information may include all or subsets of the following parameters: ETA value, ETA accuracy, ETA generating ND identification, collecting TD identification, ETA calculation system date and time, ETA sent system date and time, ETA calculation location, destination address, remaining distance, intermediate landmarks or waypoints, route reference associated with this route, stop number associated with this route, and job identification associated with this route.

ETA value may be an actual ETA value being reported. ETA accuracy can denote a level of uncertainty or confidence in the ETA value (e.g., in seconds). ETA generating ND identification can be identification of the ND that generated the ETA value. Collecting TD identification can be identification of the TD that collected the ETA value from the ND. ETA calculation system date and time may be a timestamp (i.e., date and time) of when an ETA calculation was performed. ETA sent system date and time may be a timestamp (i.e., date and time) of when information is sent. ETA calculation location may be a location (e.g., coordinates such as latitude and longitude or degrees, landmark identification, street address, system-generated reference numbers for a location, etc.) at which the ETA value was calculated. Destination address is the destination location for which the ETA value is calculated (e.g., coordinates such as latitude and longitude or degrees, landmark identification, street address, system-generated reference numbers for a location, etc.). Remaining distance may be how much distance is left before the destination is reached. Intermediate landmarks or waypoints may be one or more via points to reach the destination; via points may be coordinates such as latitude and longitude or degrees, landmark identification, street address, system-generated reference numbers for a location, etc. Route reference associated with this route may be a system-generated route reference associated with this route. Stop number associated with this route may be one or more spots where vehicle halts or pauses during the course of route. Associated job identification may be identification of the job for which the route is driven.

In another example of an exchange of information between the data center 140 and the TD 255 or TND 300, messages containing ETA configuration information may start and stop ETA information transfer and establish how ETA information is sent. ETA configuration information may be sent in a message from applications 144-148 and 153-156 to TD 255 or TND 300. Alternatively, applications 144-148 and 153-156 may send a request for existing configuration information in a message to the TD 255 or TND 300. In response to a configuration message, the TD 255 or TND 300 may save configuration information received and send an acknowledgment, or read stored configuration information and send the configuration information. ETA configuration information may include the following parameters, as well as various combinations of the parameters: vehicle identification, type of vehicle, destination ND address, ETA change time interval, ETA information time interval, ETA send location interval, ETA on change, destination address, intermediate way points, route reference, stop number, job identification, ETA enable, ETA disable, and target group. ETA change time interval may be a time period outside of which updated ETA information is sent after a change in ETA information. ETA information time interval can be an amount of time between sending ETA information. ETA send location interval may be a distance traveled between sending ETA information. ETA disable may turn off sending ETA information. ETA enable may turn on sending ETA information. Target group may define groups of entities for which ETA information is to be sent.

FIG. 4 illustrates a data center 400 according to an embodiment of the present invention. Data center 400 may include a communications server 410, storage 430, applications server 420, and data exchange 435. As readily understood by one of ordinary skill in the art, communications server 410 may include processors, memory, storage (including removable media), I/O, communications interfaces, etc. Communications server 410 may be a computer system designed to handle a wide array of communications-based applications. Storage 430 may be a database which stores information, for example, ETA information.

Application server 420 may be a computer system designed to run software applications 144-148. Application server 420, for example, may run automatic vehicle location (AVL) applications and AVL ETA management applications. Application server 420 may include processors, memory, storage (including removable media), I/O, communications interfaces, etc. AVL applications are useful for optimizing productivity of mobile assets. AVL applications, for example, may display an ETA for each vehicle 122, driver 110, co-driver 112 and other assets on a map; generate an ETA report representing the data in a tabular or graphical manner and/or as a part of a larger report of vehicle activity; generate an alarm or event indication when a vehicle, driver, or other asset does not arrive within a service time window; generate a collective ETA for vehicles traveling to a common destination; generate a report analyzing driver safety and behavior based in part upon ETA information; and compare predicted and actual ETA for a single trip or over the course of multiple trips.

AVL ETA management applications are useful for managing the receipt of information from tracking device and navigation device 120 shown in FIG. 1 (e.g., through configuration information messages). For example, AVL ETA management applications may: configure when ND 255 should send ETA information to data center 140 (e.g., when ETA changes above or below a threshold value, time interval, distance interval, etc.); enable and/or disable ETA transmission for an individual or group of NDs 255 (and associated vehicles 122); provide ETA information upon demand; and configure ETA accuracy (e.g., time and/or distance resolution).

Data exchange 435 may take data structured under a source schema and transform it into data structured under a target schema, for example, for use by applications 152-156. Applications 152-156 may include job dispatch applications, job scheduling applications, CRM applications, and the like. Data center 400 is connected to network 170 through communications server 410. As one of ordinary skill in the art would appreciate, different combinations of the above elements are possible. For example, there may be more than one each of the communications server, applications server, storage, and data exchange.

Job dispatch applications may be useful for optimizing the productivity of mobile assets. ETA information enables job dispatch applications to adjust to real-time changes to predicted conditions encountered by the mobile assets. For example, job dispatch applications can: provide ETA information for multiple vehicles 122 in real-time to dispatcher 160 and respond to delays encountered by one or more vehicles 122 (e.g., by alerting a dispatcher 160 who may notify a customer, rescheduling the appointment, and/or dispatching another vehicle to fulfill the job within the same time frame). Customer notification may be by telephone call, email message, short message service (SMS) message, extensible markup language (XML), really simple syndication (RSS) “feed,” message sent through social media (e.g., Facebook, Twitter, etc.), application programming interface (API), file transfer protocol (FTP), and the like.

Job scheduling applications may be useful for optimizing the productivity of mobile assets. ETA information enables job scheduling applicator is to adjust to real-time changes to predicted conditions encountered by the mobile assets. For example, job scheduling applications can adapt by: generating a job schedule with current ETA to job site information; rescheduling jobs when an appointment does not fall within the limits of a service level agreement (SLA) based upon changes in ETA; generating benchmarks for individual or a group of vehicles based upon ETA and SLA information (optionally in real time); and determining the effectiveness of the job scheduling application based upon ETA and SLA (i.e., how often do actual service levels conform to the SLA?).

CRM applications may be useful for maintaining and advancing customer relationships. ETA information enables CRM applications to communicate changes to scheduled (or at least expected by the customer) events such as appointments or delivery times. In addition, ETA information may be included in historical (trend) analysis of performance (e.g., on-time performance over time). For example, CRM applications can communicate by: providing ETA indications to a customer; generating a history comparing promised and actual delivery times; enabling a customer to reschedule an appointment if the current ETA is not acceptable; enabling a customer to accept an appointment that is earlier than originally scheduled; enabling a customer to share personal ETA information with pre-designated, trusted third parties; and providing information about local services (e.g., restaurants, financial institutions, retail stores, laundry, etc.) which the customer may patronize while waiting for service to arrive. Customer notification may be by telephone call, email message, short message service (SMS) message, message sent through social media (e.g., Facebook, Twitter, etc.), and the like.

Other example applications may also benefit from using ETA information, such as: enterprise resource planning (ERP); maintenance, repair, and overhaul/operations (MRO); field service; shipping and distribution systems; transportation of people; and transportation of goods. For ERP, ETA information may be used to optimize resources such as vehicles, field service personnel, drivers, and the like. For example, ETA information may be used to analyze resource usage against ETA by distance from service locations, compare predicted and actual ETA differences against customer satisfaction and SLA obligations; perform resource planning (optionally by geographic region) by setting on-time arrival targets and simulating routes with historic ETA information. For MRO, ETA information may be used optimize repair and maintenance operations. For example, ETA information may be used to dispatch a technician with the shortest ETA (i.e., arrive on site the soonest); dispatch a technician with the shortest ETA for high priority tasks; and dispatch a technician with the shortest ETA for unplanned events.

For shipping and distribution systems, ETA information may be helpful to prevent waste and for logistics planning. For example ETA information may be used by shipping and distribution systems to: direct perishable cargo to facilities with the shortest ETA (e.g., returned to refrigerated storage sooner); enable warehouse staff advance notice to prepare facilities to receive cargo; and plan shortest shipping routes based upon historic ETA information. For transportation of people, ETA information may be used to: provide ETA updates to customers waiting for a taxi or other transportation via email message, SMS message, and/or social media web site; dispatch a taxi or other transportation such that the predicted ETA matches the customer's requested pick up time; and publish ETA at specified locations (e.g., station) for vehicles that follow a fixed route (e.g., bus, subway, train, etc.). For cargo transportation, ETA information may be used to: notify customers when a shipment will be available at a designated pickup location; enable warehouse staff advance notice to prepare facilities to receive cargo; and notify a customer when a shipment will arrive at the customer's location, so the customer may plan for accepting the delivery.

From the foregoing it will be appreciated that, although specific embodiments of the invention have been described herein for purposes of illustration, various modifications may be made without deviating from the spirit and scope of the invention. Such modifications are well within the skill of those ordinarily skilled in the art. Accordingly, the invention is not limited except as by the appended claims.

1. An apparatus for using vehicle estimated time of arrival (ETA) information comprising:
a navigation device configured to be located in a vehicle, the navigation device including a Global Positioning System (GPS) navigation system which determines the vehicle's present location, and a first processor configured to determine a route traveled by the vehicle and ETA information based upon the vehicle's present location;
a tracking device coupled to the navigation device and including a second processor, the tracking device configured to provide the ETA information from the navigation device on a network;
a network connection coupled to the tracking device, the network connection configured to transmit the ETA information to a recipient outside of the vehicle.

2. The apparatus of claim 1, wherein the tracking device is coupled to a sensor configured to sense a condition of the vehicle.

3. The apparatus of claim 1, wherein the navigation device and the tracking device are in communication through a bus.

4. The apparatus of claim 1, wherein the navigation device and the tracking device comprise a single device.

5. The apparatus of claim 4, wherein the first processor and the second processor comprise a single processor.

6. The apparatus of claim 1, further comprising:
a data center in communication with the tracking device through the network connection, the data center configured to receive and store the present location and the route of the vehicle, and further configured to determine ETA information based upon the vehicle's present location and the route, wherein
the tracking device receives the route from the navigation device and transmits the present location and the route of the vehicle through the network connection to the data center.

7. The apparatus of claim 1, further comprising:
a data center in communication with the tracking device through the network connection, the data center configured to receive the ETA information.

8. The apparatus of claim 7, wherein the data center further comprises:
a data base configured to store the ETA information; and
a data exchange coupled to the data base, the data exchange configured to transform the ETA information for use by external applications.

9. The apparatus of claim 8, wherein an external application is configured to update a schedule for a plurality of vehicles based at least in part on changes to the ETA information for each vehicle.

10. The apparatus of claim 8, wherein an external application is configured to use the ETA information to communicate to a customer changes to an appointment time.

11. The apparatus of claim 10, wherein the changes to the appointment time are communicated to the customer through at least one of a telephone call, an email, an SMS message, and social media.

12. The apparatus of claim 7, wherein the data center further comprises:
a data base which stores the ETA information; and
an application server coupled to the data base, the application server configured to run internal applications.

13. The apparatus of claim 12, wherein
an internal application is configured to use the ETA information to report when each of a plurality of vehicles will arrive at a respective vehicle's destination.

14. A method for using vehicle estimated time of arrival (ETA) information comprising:
receiving the ETA information from a tracking device over a wireless network;
storing the ETA information in a data base; and
using the ETA information to manage mobile resources.

15. The method of claim 14, further comprising:
transforming information in the data base for use by external applications.

16. The method of claim 15, further comprising:
updating a schedule for a plurality of vehicles based at least in part on changes to the ETA information for each vehicle

17. The method of claim 16, further comprising:
communicating to a customer changes to an appointment time based at least in part on the ETA information.

18. The method of claim 17, wherein the changes to an appointment time are communicated to the customer through at least one of a telephone call, an email, an SMS message, and social media.

19. The method of claim 15, further comprising:
reporting when each of a plurality of vehicles will arrive at a respective vehicle's destination.

20. A method for using vehicle estimated time of arrival (ETA) information comprising:
receiving current location information from a GPS navigation system;
determining a route from the current location to a destination;
determining ETA information based on the current location and the route; and
transmitting the ETA information over a network to a data center in communication with a tracking device located in the vehicle.

21. The method of claim 20, wherein
the route is determined using a map database.

22. The method of claim 20, wherein
the ETA information is provided to the data center over a wireless network.

23. The method of claim 19, further comprising:
determining new ETA information after a predefined time and/or distance interval; and
providing new ETA information to the data center.

24. A computer-readable medium having stored thereon instructions that, when executed, direct a processor to:
receive current location information for a vehicle from a GPS navigation system;
determine a route from the current location to a destination;
determine ETA information based on the current location and the route to the destination; and
transmit the ETA information over a network to a data center in communication with a tracking device located in the vehicle.

25. The computer readable medium of claim 24, further having stored thereon instructions that, when executed, direct a processor to:
determine a route using a map database.

26. The computer readable medium of claim 24, further having stored thereon instructions that, when executed, direct a processor to:
provide the ETA information over a wireless network.

27. The computer readable medium of claim 24, further having stored thereon instructions that, when executed, direct a processor to:
determine new ETA information after a predefined time and/or distance interval; and
transmit new ETA information to the data center.

28. A system for using ETA information comprising:
a server configured to request and receive the ETA information;
a wireless network coupled to the server;
a tracking device configured to provide the ETA information to the server over the wireless network; and
a navigation device configured to calculate ETA information, the navigation device coupled to the tracking device

29. The system of claim 28 wherein the tracking device and the navigation device comprise a single device.

30. The system of claim 28 wherein the server is further configured to send job information to the tracking device, the job information comprising at least a destination, and wherein the tracking device is further configured to send ETA information responsive to the job information.

31. The system of claim 28 wherein the server is further configured to send job information to the tracking device, the job information comprising a plurality of destinations, and wherein the tracking device is further configured to send ETA information for each of the plurality of destinations responsive to the job information.

32. The system of claim 28 wherein the tracking device is further configured to receive job information from a driver, the job information comprising at least a destination.

33. The system of claim 28 further comprising:
a network, the network coupled to the server; and
a computer system coupled to a network, the computer system configured to send an ETA information request to the server.

34. The system of claim 33, wherein the server is further configured to request ETA information from at least one tracking device responsive to the ETA information request.

35. The system of claim 33, wherein the server is further configured to determine ETA information responsive to the ETA information request.
